(19) United States
(12) Patent Application Publication
(10) Pub. No.: US 2025/0191314 A1
(43) Pub. Date: Jun. 12, 2025

(54) DISPLAY DEVICE, DISPLAY METHOD, AND NON-TRANSITORY STORAGE MEDIUM

(71) Applicant: JVCKENWOOD Corporation, Yokohama-shi (JP)

(72) Inventor: Hiroshi Noguchi, Yokohama-shi (JP)

(21) Appl. No.: 19/059,335

(22) Filed: Feb. 21, 2025

Related U.S. Application Data
(63) Continuation of application No. PCT/JP2023/035168, filed on Sep. 27, 2023.

(30) Foreign Application Priority Data
Sep. 27, 2022 (JP) 2022-153256

(51) Int. Cl. G06T 19/00

(52) U.S. Cl. CPC G06T 19/006; G06T 2219/2004

(57) ABSTRACT

A display device includes: a target object extraction unit configured to extract a target object that is included in a main image captured by an image capturing unit; a first object generation unit configured to generate a first object that is an image obtained by compensating for the target object based on the target object; a superimposed position setting unit configured to set a superimposed position that is a position at which the first object is displayed in the main image; a display object generation unit configured to set a display mode of the first object based on a position of another object that is superimposed onto the target object included in the main image and based on the superimposed position, and to generate a display object; and a display controller configured to cause the display object to be displayed at the superimposed position.

### CROSS-REFERENCE TO RELATED APPLICATIONS

This application is a Continuation of PCT International Application No. PCT/JP2023/035168 filed on Sep. 27, 2023 which claims the benefit of priority from Japanese Patent Application No. 2022-153256 filed on Sep. 27, 2022, the entire contents of both of which are incorporated herein by reference.

### FIELD OF THE INVENTION

The present application relates to a display device, a display method, and a non-transitory storage medium.

### BACKGROUND OF THE INVENTION

There is a known technology for displaying an image by superimposing a certain image onto another image, referred to as Mixed Reality (MR) or the like, by superimposing an object such as an avatar onto a real space and displaying the superimposed image. For example, Japanese National Publication of International Patent Application No. 2006-528381 discloses a technology capable for dynamically combining an object present in a virtual environment with another object and separating the objects when an interactive virtual environment is controlled.

When the images are displayed in a superimposed manner as described above, there is a need to suppress a feeling of strangeness felt by a user who visually recognizes the displayed image.

### SUMMARY OF THE INVENTION

A display device, a display method, and a non-transitory storage medium are disclosed.

According to one aspect of the present application, there is provided a display device comprising: a target object extraction unit configured to extract a target object that is included in a main image captured by an image capturing unit; a first object generation unit configured to generate a first object that is an image obtained by compensating for the target object based on the target object; a superimposed position setting unit configured to set a superimposed position that is a position at which the first object is displayed in the main image; a display object generation unit configured to set a display mode of the first object based on a position of another object that is superimposed onto the target object included in the main image and based on the superimposed position, and to generate a display object; and a display controller configured to cause the display object to be displayed at the superimposed position.

According to one aspect of the present application, there is provided a display method comprising: extracting a target object that is included in a main image captured by an image capturing unit; generating a first object that is an image obtained by compensating for the target object based on the target object; setting a superimposed position that is a position at which the first object is displayed in the main image; setting a display mode of the first object based on a position of another object that is superimposed onto the target object included in the main image and based on the superimposed position, and generating a display object; and displaying the display object at the superimposed position.

According to one aspect of the present application, there is provided a non-transitory storage medium that stores a program that causes a computer to execute a process comprising: a step of extracting a target object that is included in a main image captured by an image capturing unit; a step of generating a first object that is an image obtained by compensating for the target object based on the target object; a step of setting a superimposed position that is a position at which the first object is displayed in the main image; a step of setting a display mode of the first object based on a position of another object that is superimposed onto the target object included in the main image and based on the superimposed position, and generating a display object; and a step of displaying the display object at the superimposed position.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a diagram illustrating one example of a display device according to the present embodiment;

FIG. 2 is a diagram illustrating one example of an image displayed by the display device;

FIG. 3 is a schematic block diagram illustrating a display device according to a first embodiment;

FIG. 4 is a schematic diagram illustrating an example of a method of generating a first object;

FIG. 5 is a schematic diagram illustrating another example of a method of setting a superimposed position;

FIG. 6 is a schematic diagram illustrating one example of an image displayed by the display device;

FIG. 7 is a flowchart illustrating a flow of processes performed by the display device according to the present embodiment; and

FIG. 8 is a schematic diagram illustrating one example of an image displayed by the display device according to a second embodiment.

### DETAILED DESCRIPTION OF THE INVENTION

In the following, preferred embodiments disclosed in the present application will be described in detail below with reference to the accompanying drawings. Furthermore, the present application is not limited to the embodiments described below.

### First Embodiment

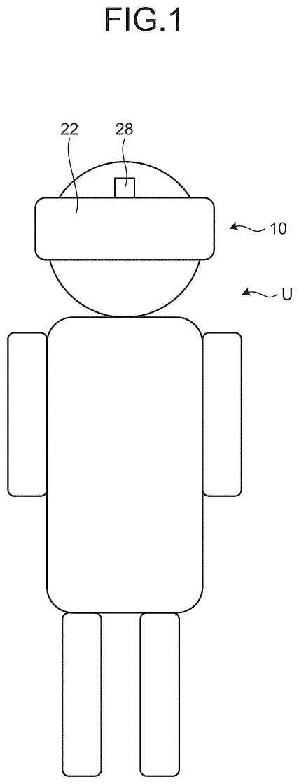

FIG. 1 is a diagram illustrating one example of a display device according to the present embodiment. A display device 10 according to the first embodiment is a device that provides information to a user U by outputting visual stimulation to the user U. As illustrated in FIG. 1, the display device 10 is what is called a wearable device that is worn on a body of the user U. In an example described in the present embodiment, the display device 10 is a head-mounted display that is worn on eyes of the user U and that outputs visual stimulation to the user U (displays an image). However, the configuration illustrated in FIG. 1 is one example, and an arbitrary number of devices may be used and a position to be worn on the user U may be an arbitrary position. For example, the display device 10 is not limited to a wearable device, but may be a device, such as what is called a smartphone or a tablet terminal, that is carried by the user U, for example.

### Main Image

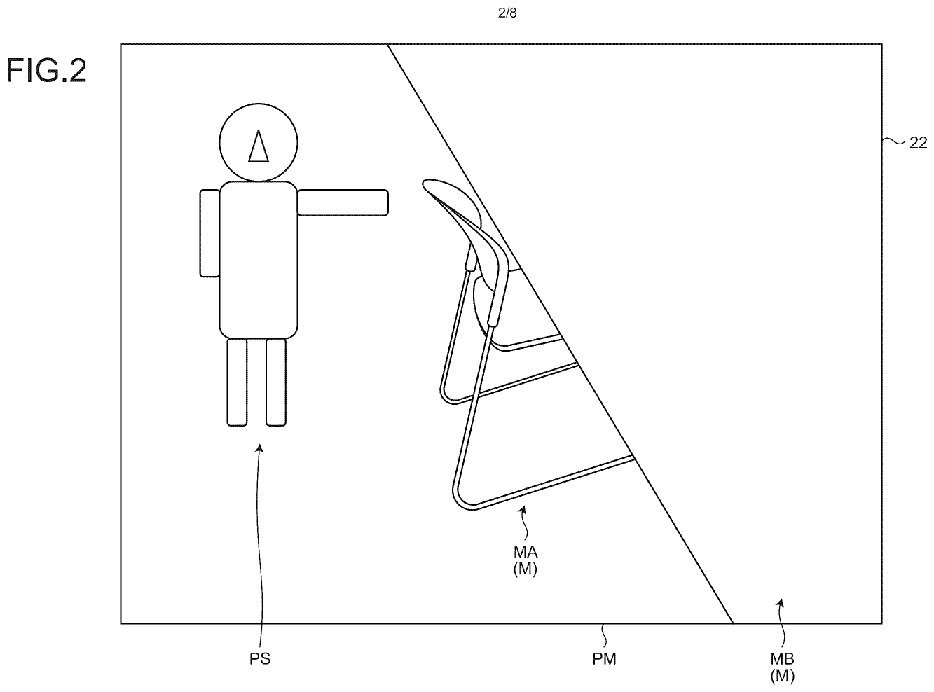

FIG. 2 is a diagram illustrating one example of an image displayed by the display device. As illustrated in FIG. 2, the display device 10 provides a main image PM to the user U by way of a display 22. As a result, the user U who has worn the display device 10 is able to visually recognize the main image PM. It can also be said that the main image PM mentioned here is, in the present embodiment, an image of a scenery that the user U is going to visually recognize when it is assumed that the user U does not wear the display device 10, and is an image that includes a real object included in a range of a visual field of the user U. The range of the visual field mentioned here indicates a range that can be seen without moving eyeballs of the user U centered on a line of sight. In the present embodiment, the display device 10 causes the display unit 22 to display the image located within the range of the visual field of the user U captured by the image capturing unit 28 as the main image PM. In this case, the user U consequently visually recognizes the image of a view displayed on the display 22 as the main image PM. However, the image is not limited to this. For example, the display device 10 may also provide the main image PM to the user U by allowing outside light (surrounding visible light) to pass the display unit 22. In other words, the display device 10 may cause an image of the actual view to be directly and visually recognized as the main image PM through the display unit 22. Furthermore, in FIG. 2, as an example of an object M included in the main image PM, an object MA that is a chair and an object MB that is a desk are illustrated, but these objects are just one example. Furthermore, it can be said that the object M included in the main image PM is an image that indicates an object when the main image PM is displayed by the display 22, and is a real image of an object when an actual view is visually recognized as the main image PM.

### Sub Image

As illustrated in FIG. 2, the display device 10 causes the display 22 to display a sub image PS such that the sub image PS is superimposed onto the main image PM that is provided by the display unit 22. As a result of this, the user U visually recognizes the image in which the sub image PS is superimposed onto the main image PM. It can be said that the sub image PS mentioned here is an image that is superimposed onto the main image PM, and is an image other than a real-world sight that is present within the range of the visual field of the user U. In other words, it can be said that the display device 10 provides mixed reality (MR) or augmented reality (AR) to the user U by causing the sub image PS to be superimposed onto the main image PM. In the example illustrated in FIG. 2, an avatar of a person other than the user U is displayed as the sub image PS.

### Display Device

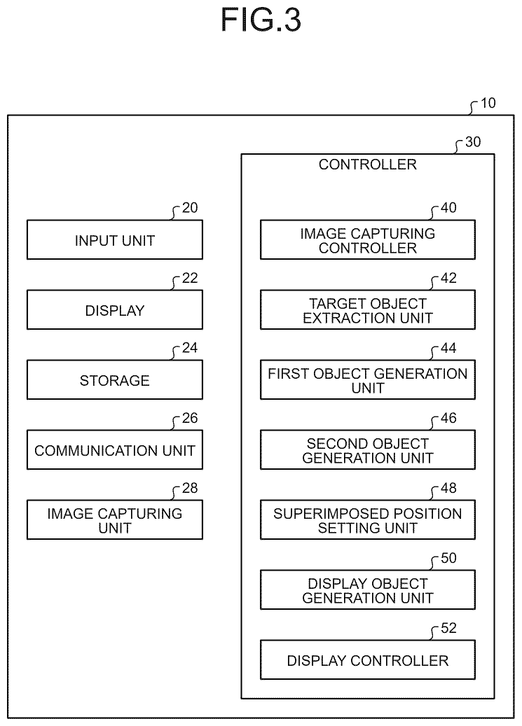

FIG. 3 is a schematic block diagram illustrating the display device according to the first embodiment. As illustrated in FIG. 3, the display device 10 includes an input unit 20, the display 22, a storage 24, a communication unit 26, the image capturing unit 28, and a controller 30.

The input unit 20 is a device that receives an operation performed by the user, and may be, for example, a controller, a touch panel, or the like. The display 22 is a display that displays an image. In the present embodiment, the display 22 is what is called a head mounted display (HMD). Furthermore, in addition to the display 22, an audio outputting unit (speaker) that outputs a sound and a tactile stimulation output unit that outputs tactile stimulation to the user U may be provided as the output unit. The tactile stimulation output unit outputs tactile stimulation to the user by a physically operation like vibrations, but the type of tactile stimulation is not limited to vibrations and an arbitrary type of tactile stimulation may be used.

The storage 24 is a memory that stores therein various kinds of information such as arithmetic content and a program of the controller 30, and includes at least one of, for example, a main storage device such as a random access memory (RAM) or a read only memory (ROM), and an external storage device such as a hard disk drive (HDD). The program that is used for the controller 30 and that is stored by the storage 24 may be stored in a recording medium that can be read by the display device 10.

The communication unit 26 is a module that communicates with a device provided outside, and may include, for example, an antenna or the like. A method of communication performed by the communication unit 26 is wireless communication in the present embodiment, but an arbitrary communication method may be used.

The image capturing unit 28 is a camera that captures an image of the target object located within the range of the visual field of the user U. The image capturing unit 28 is provided at a position at which an image capturing range overlaps with the range of the visual field of the user U. In the example illustrated in FIG. 1, the image capturing unit 28 is installed such that an image capturing direction is the same as a direction in which a face of the user U is facing. As a result of this, the image capturing unit 28 is able to capture an image of the target object located within the range of the visual field of the user U. Furthermore, the image capturing unit 28 may be a video camera that captures an image for each predetermined frame rate. The number of the image capturing unit 28 used here may be an arbitrary number, and a single piece of the image capturing unit 28 may be used or multiple image capturing units 28 may be used.

The controller 30 is an arithmetic unit and includes an arithmetic circuit such as a central processing unit (CPU), for example. The controller 30 includes an image capturing controller 40, a target object extraction unit 42, a first object generation unit 44, a second object generation unit 46, a superimposed position setting unit 48, a display object generation unit 50, and a display controller 52. The controller 30 implements the image capturing controller 40, the target object extraction unit 42, the first object generation unit 44, the second object generation unit 46, the superimposed position setting unit 48, the display object generation unit 50, and the display controller 52 by reading programs (software) from the storage 24 and executing the programs (software).

Furthermore, the controller 30 may perform these processes by using a single piece of CPU, or, alternatively, multiple CPUs may be provided in the controller 30 and the controller 30 may perform these processes by using the multiple CPUs. Furthermore, at least a part of the image capturing controller 40, the target object extraction unit 42, the first object generation unit 44, the second object generation unit 46, the superimposed position setting unit 48, the display object generation unit 50, and the display controller 52 may be implemented by hardware.

### Image Capturing

The image capturing controller 40 causes the image capturing unit 28 to capture an image by controlling the image capturing unit 28, and acquires the image (image data) captured by the image capturing unit 28. In other words, the image capturing controller 40 acquires the image data of the main image PM captured by the image capturing unit 28 and with the range of the visual field of the user U as the image capturing range. The image capturing controller 40 causes the image capturing unit 28 to capture an image at a predetermined period of time. The image capturing controller 40 acquires the image data of the image captured by the image capturing unit 28 every time the image capturing unit 28 captures an image.

### Extraction of Target Object

The target object extraction unit 42 extracts a target object from the main image PM that has been captured by the image capturing controller 40. The target object mentioned here indicates an image of the object M that is included in the main image PM and that is referred to when a display object P described later is generated. In the present embodiment, the target object extraction unit 42 extracts, from the main image PM, the objects M that are included in the main image PM, and selects the target object included in the extracted objects M. An arbitrary method may be used for the method of extracting the objects M, and a known image recognition technology may be used. In the example illustrated in FIG. 2, the target object extraction unit 42 extracts the object MA that is a chair as the target object.

The target object extraction unit 42 may extract (select) the target object by using an arbitrary method. For example, the target object extraction unit 42 may extract the object M that has been selected by the user U as the target object from among the objects M included in the main image PM. In this case, for example, the display device 10 may display, on the display 22, both of the main image PM and information for identifying the object M included in the main image PM (for example, a pointer or the like that points to the object M). The user U inputs the object M to be selected to the input unit 20 while visually recognizing the main image PM. The target object extraction unit 42 extracts the selected object M that has been input by the input unit 20 as the target object. In addition, for example, the target object extraction unit 42 may automatically extract (select) the target object regardless of the selection of the user U. In this case, for example, the target object extraction unit 42 identifies a type of the extracted object M, and selects the object M having the same type of a predetermined type (a type that has been set in advance to be the type of the target object) as the extracted object. The type of the object mentioned here indicates an attribute of the object when the object is classified based on a predetermined classification reference. Here, an arbitrary classification reference may be used for the classification reference. Moreover, an arbitrary method may be used for the method of identifying the type of the object M. For example, the target object extraction unit 42 may identify the type of the object M by inputting the image data of the object M to an artificial intelligence (AI) model (program) in which an association relationship between the type of the object and a feature value of the image data of the object has been trained as machine learning.

### Generation of First Object

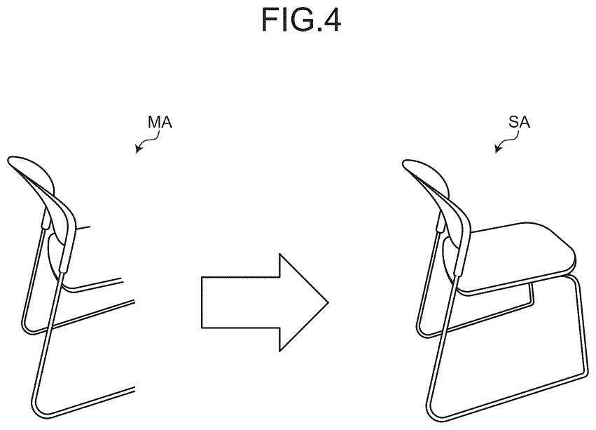

FIG. 4 is a schematic diagram illustrating an example of generating a first object. The first object generation unit 44 generates a first object SA based on the target object extracted by the target object extraction unit 42. The first object SA is a source image of an object (a display object P described later) that is superimposed onto the main image PM as the sub image PS. Furthermore, the first object SA mentioned here is a compensated image for the target object, and is preferably a three-dimensional (3D) image (three-dimensional image data). In other words, for example, in a case in which a part of a certain object is located behind another object when viewed from the user U and the certain object is regarded as the target object, the target object is extracted as an image in which the part behind the other object is missing. In this case, the first object generation unit 44 may generate, as the first object SA, an image in which the missing part behind the other object is compensated. Furthermore, for example, when the target object is a two-dimensional (2D) image (two-dimensional plane image data), the first object generation unit 44 may generate, as the first object SA, the image in which another piece of one-dimensional information is compensated for the two-dimensional image data of the target object. In the example illustrated in FIG. 4, the object MA that is the target object is an image in which the part behind the object MB is missing. Accordingly, the first object generation unit 44 compensates the missing part for the target object and further compensates other one-dimensional information, to generate the first object SA that is the 3D image of the entire chair.

The first object generation unit 44 may generate the first object SA by using an arbitrary method based on the target object, and an example of the method of generating the first object SA used in the present embodiment will be described below. In the example illustrated in the present embodiment, image data (3D image data in the present embodiment) of multiple objects is stored in the storage 24, and the first object generation unit 44 extracts an object having a shape similar to that of the target object from among the stored objects by using the AI model trained as machine learning. The AI model used in this case may be an AI model in which the feature values of the image data of the objects to be compared with and degree of similarity between the objects have been trained as machine learning. Then, the first object generation unit 44 converts the target object that is a 2D image to a 3D image by using a known method, and calculates the degree of similarity by inputting both of 3D image data of the target object and the image data of each of the stored objects to the AI model. The first object generation unit 44 selects, from among the objects, an object in which the degree of similarity is equal to or greater than a predetermined value (for example, the highest value) as a compensation purpose object. The first object generation unit 44 generates the first object SA based on the obtained compensation purpose object. Specifically, the first object generation unit 44 generates the first object SA in which the target object has been compensated by identifying the missing part of the target object, extracting the missing part from the compensation purpose object, and combining the target object with the extracted part from the compensation object. However, the method of generating the first object SA is not limited to this. Alternatively, for example, the extracted compensation purpose object may be used as the first object SA.

### Generation of Second Object

The second object generation unit 46 generates a second object SB. The second object SB is a source image of an object (a display object S) that is superimposed onto the main image PM as the sub image PS. Although a description thereof in detail will be described later, the display device 10 generates an image that includes both of the first object SA and the second object SB as the display object S, and superimposes the display object S on the main image PM to be displayed as the sub image PS. It is preferable that, in the display object S, the second object SB is arranged at a position within a predetermined distance with respect to the first object SA, and it is more preferable that the second object SB is arranged so as to be superimpose onto the first object SA. In the example illustrated in the present embodiment, the second object SB is an avatar of a person other than the user U, and is displayed such that the second object SB is superimposed onto the first object SA that is the chair.

The second object generation unit 46 may generate the second object SB by using an arbitrary method. For example, the image data of the second object SB has been set in advance, and the second object generation unit 46 may read the image data of the second object SB that has been set in advance, and generate the second object SB. Furthermore, similarly to the first object SA, the second object SB may also be a 3D image (three-dimensional image data).

### Setting of Superimposed Position

The superimposed position setting unit 48 sets a superimposed position in the main image PM. The superimposed position mentioned here is a position at which the first object SA (the display object S described later) is displayed in the main image PM (in a coordinate system of the main image PM). The superimposed position setting unit 48 may set the superimposed position at an arbitrary position, but, in the present embodiment, it is preferable that the position that is different from the position of the target object is set as the superimposed position. In other words, for example, it is preferable that the superimposed position setting unit 48 sets the superimposed position such that the compensated image (display object S) from the chair is displayed at a position that is different from the original position of the chair (the object MA). Furthermore, the different position (another position) mentioned here is not limited to a case in which each of the objects does not have any superimposed portion (two objects do not completely overlap each other), but may include a position at which parts of the objects may overlap each other.

Furthermore, when it is assumed that the display object S is displayed at the superimposed position, it is preferable that the superimposed position setting unit 48 calculates an area in which both of the second object SB included in the display object S and the other object (in this example, the object MB) are superimposed each other, and sets the position at which the superimposed area indicates a value equal to or less than a predetermined value as the superimposed position. The other object MB mentioned here indicates the object M that is included in the main image PM and that is other than the target object MA, and is the object that is superimposed onto the target object MA in the main image PM. Furthermore, the other object MB indicates an object that is located in front of the target object MA with respect to the image capturing unit 28, and indicates an object that hides the target object MA. Furthermore, when multiple objects corresponding to the other object MB are present, it may be possible to select the other object MB having the largest superimposed area in which the other object MB is superimposed onto the target object MA. The superimposed position setting unit 48 may use the object assigned by the input unit 20 as the other object MB. Alternatively, the superimposed position setting unit 48 may set the other object MB based on the target object MA, the first object SA, and the main image PM. For example, the superimposed position setting unit 48 acquires the target object MA from the target object extraction unit 42, acquires the first object SA from the first object generation unit 44, and acquires the main image PM from the image capturing controller 40. The superimposed position setting unit 48 aligns the position of the first object SA with respect to the target object MA in the main image PM, and determines an object that is superimposed onto the object to be compensated by the first object SA. The superimposed position setting unit 48 identifies the determined object as the other object MB.

In other words, for example, it can be said that the superimposed position setting unit 48 preferably sets the superimposed position such that the degree of superimposition of the avatar (the second object SB) that is superimposed onto the chair (the first object SA) with respect to the object (the object MB corresponding to the desk) other than the chair becomes small. For example, in this case, the superimposed position setting unit 48 may calculate a position, based on optimization calculation, at which areas in which the second object SB and the other objects M other than the target object MA are superimposed become as small as possible, and may set the calculated position to the superimposed position. Furthermore, it is possible to calculate the superimposed area based on a size of the second object SB and a size of each of the other objects, and based on the superimposed position and the positions of the other objects.

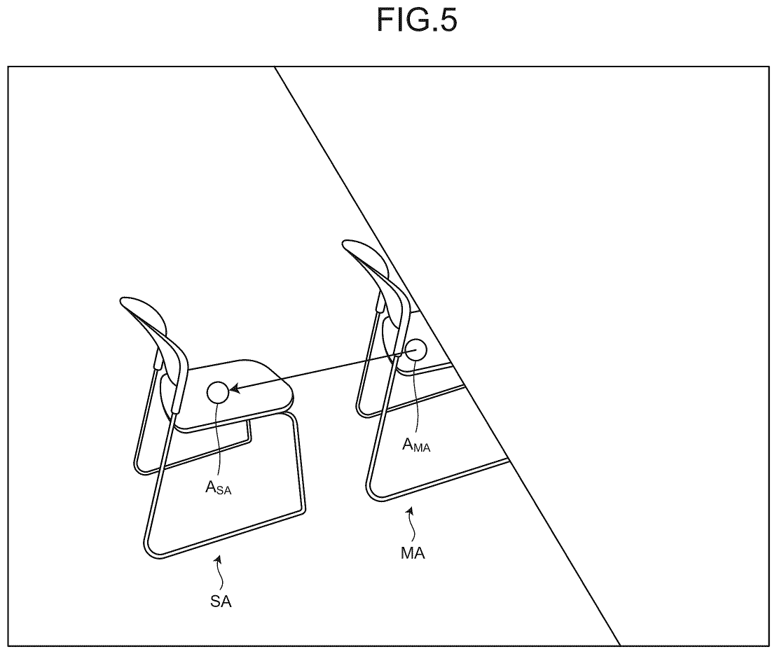

FIG. 5 is a schematic diagram illustrating another example of a method of setting the superimposed position. The superimposed position may be set by the user U. In this case, for example, the display device 10 causes the display unit 22 to display the main image PM, and the user U inputs the superimposed position to the input unit 20 while visually recognizing the displayed main image PM. The target object extraction unit 42 sets the superimposed position that has been input to the input unit 20 as the superimposed position. In this case, for example, as illustrated in FIG. 5, the display device 10 may display, on the display 22, an image (in this example, a pointer) that indicates a reference position A_{MA} of the object MA (for example, a center position of the target object MA) that is the target object. Then, when a position A_{SA} is designated as the superimposed position by the user U, the display device 10 displays the image (in this example, the pointer) that indicates the position A_{SA} that is the superimposed position and the image of the target object MA displayed at the position A_{SA} in a superimposed manner with respect to the main image PM. As a result of this, for example, it is possible to allow the user to appropriately recognize where the image of the chair that is the target object MA is to be moved.

### Generation of Display Object

The display object generation unit 50 sets a display mode of the first object SA, and generates the display object S. In other words, it can be said that the display object S is an image that has been generated based on the first object SA, and the display mode thereof is different from that of the first object SA.

An arbitrary method may be used to generate the display object S based on the first object SA, and, in the present embodiment, the display object generation unit 50 generates the display object S from the first object SA based on the position of the other object (the object M other than the target object MA) included in the main image PM and based on the superimposed position that has been set by the superimposed position setting unit 48. For example, the display object generation unit 50 calculates, based on the superimposed position and the position of the other object, a region in which the first object SA is superimposed onto the other object (in this example, the object MB) when it is assumed that the first object SA is displayed at the superimposed position. Then, the display object generation unit 50 may use the image in which the superimposed region is missing from the first object SA as the display object S. Furthermore, for example, the display object generation unit 50 may calculate an orientation of the first object SA included in the main image PM based on the superimposed position and a direction in which a face of the user U is oriented (a direction in which the user U visually recognizes), generate a 2D image corresponding to the orientation of the first object SA from the first object SA of the 3D image, and use the generated 2D image as the display object S. An arbitrary method may be used to acquire the direction in which the face of the user U is oriented, but, for example, the display object generation unit 50 may estimate the direction in which the face of the user U is oriented from a detection result obtained by a sensor that is mounted on the display device 10. An arbitrary sensor may be used for the sensor that is used here, and, for example, the image capturing unit 28, a gyroscope sensor (not illustrated), a light detection and ranging (LiDAR) sensor (not illustrated), or the like may be used. The display object generation unit 50 may estimate the direction in which the face of the user U is oriented by using, for example, a simultaneous localization and mapping (SLAM) technology.

In the present embodiment, as described above, the image that includes the first object SA and the second object SB is used as the display object S. In other words, it can be said that the display object S is an image that has been generated based on the first object SA and the second object SB, and the display mode there of is different from those of the first object SA and the second object SB. For example, the display object generation unit 50 may calculate, based on the superimposed position and the position of the other object, a region that is superimposed onto the other object (in this example, the object MB) from among the first object SA and the second object SB when it is assumed that the first object SA and the second object SB are displayed at the superimposed position. Then, the display object generation unit 50 may use the image in which the superimposed region is missing from the first object SA and the second object SB as the display object S. Furthermore, for example, the display object generation unit 50 may calculate the orientation of each of the first object SA and the second object SB included in the main image PM based on the superimposed position and the direction in which the face of the user U is oriented, generate the 2D image corresponding to the orientation of the first object SA and the 2D image corresponding to the orientation of the second object SB from the first object SA and the second object SB that are the 3D images, and use the image including these 2D images as the display object S.

### Display of Display Object

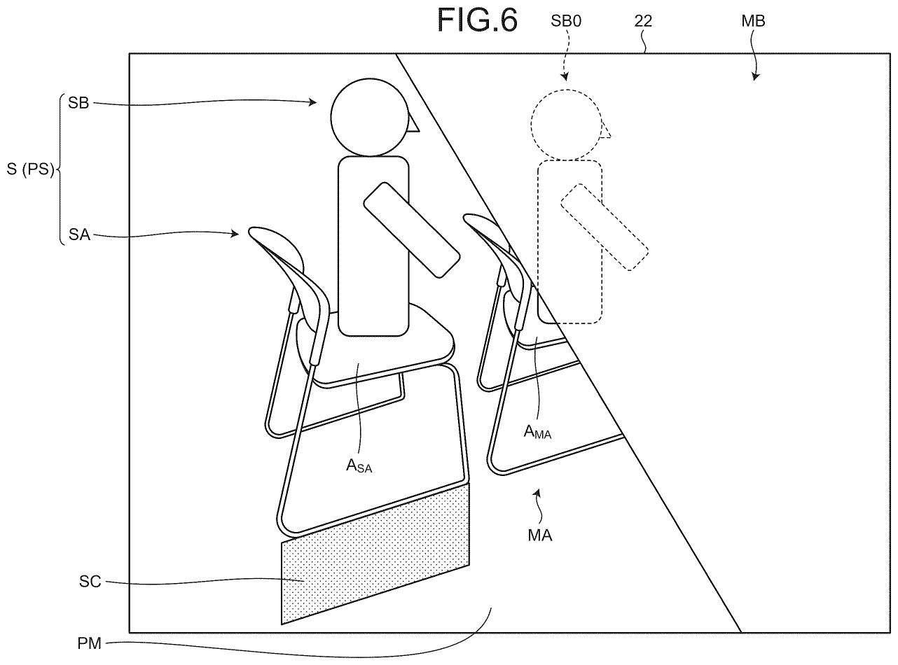

FIG. 6 is a schematic diagram illustrating one example of an image displayed by the display 22. The display controller 52 controls the display 22, and causes the display 22 to display an image. The display controller 52 causes the display object S that has been generated by the display object generation unit 50 to be displayed at the superimposed position. In other words, as indicated by the example illustrated in FIG. 6, the display controller 52 uses the display object S as the sub image PS, and causes the display unit 22 to display the main image PM and the display object S that is located at the superimposed position. In other words, in the example illustrated in FIG. 6, the main image PM that includes the objects MA and MB, and the display object S that includes the first object SA that is the chair and the second object SB that is the avatar are displayed in a superimposed manner at the position A_{SA} that is the superimposed position. Furthermore, when the display object S overlaps the target object MA, the display controller 52 displays the image such that the part of the target object MA overlapped with the display object S is missing, in other words, such that the display object S is located in front of the target object MA. On the other hand, as described above, it is preferable that the part of the display object S that is superimposed onto the other object MB is preferred to be missed, so that the image of the other object MB may be displayed so as to be located in front of the display object S.

Furthermore, as illustrated in FIG. 6, the display object generation unit 50 may generate a shadow image SC corresponding to a shadow of the display object, and also display the shadow image SC together with the display object S in the main image PM in a superimposed manner. The shadow image SC mentioned here is an image indicating a shadow of the display object S obtained when it is assumed that the display object S is actually present in a space included in the main image PM. An arbitrary method may be used to generate the shadow image SC, and, for example, the display object generation unit 50 calculates an estimated light source position based on the main image PM. The estimated light source position mentioned here is an estimated position of the light source that emits light to the space included in the main image PM. The display object generation unit 50 may calculate the estimated light source position from the image data (for example, a gray scale value or a luminance of each pixel) of the main image PM by using a known method. Then, the display object generation unit 50 calculates the position of the shadow generated when the display object S is arranged at the superimposed position from the positional relationship between the estimated light source position and the superimposed position (the display position of the display object S), and causes the shadow image SC to be displayed at the calculated position of the shadow.

### Flow of Process

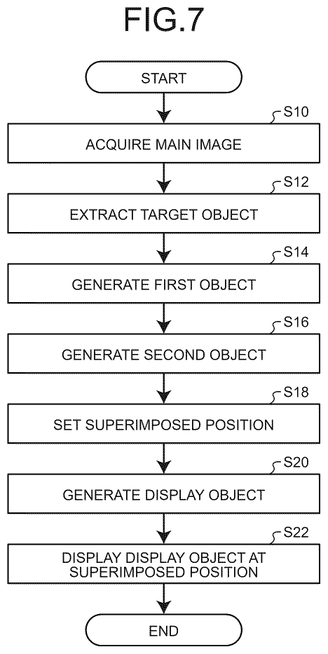

FIG. 7 is a flowchart illustrating a flow of processes performed by the display device according to the present embodiment. As illustrated in FIG. 7, the display device 10 causes the image capturing controller 40 to acquire the image data of the main image PM (Step S10), and causes the target object extraction unit 42 to extract the target object MA from the main image PM (Step S12). Then, the display device 10 causes the first object generation unit 44 to generate the first object SA based on the target object MA (Step S14), causes the second object generation unit 46 to generate the second object SB (Step S16), and causes the superimposed position setting unit 48 to set the superimposed position (Step S18). Furthermore, the timing at which the process of generating the second object SB performed at Step S16 is not limited to the timing after the generation of the first object SA, but may be any timing before the generation of the display object S performed at Step S20 described later. Furthermore, also, the process of setting the superimposed position performed at Step S18 is not limited to the timing after the generation of the second object SB, but may be any timing before the generation of the display object S performed at Step S20 described later.

Then, the display device 10 causes the display object generation unit 50 to set the display mode of the first object SA and the second object SB based on the position of the other object MB and the superimposed position, to generate the display object S (Step S20), and causes the display controller 52 to display the display object S at the superimposed position (Step S22).

As described above, in the present embodiment, the display object S is generated by adjusting the display mode of the first object SA that is obtained by compensating for the target object MA based on the superimposed position and the position of the other object MB. Then, the display object S generated in this way is allowed to be displayed at the superimposed position. Accordingly, it is possible to display the target object MA as the display object S by adjusting the display mode in accordance with the positional relationship with the other object MB. As a result of this, it is possible to reduce a feeling of strangeness about an appearance caused by the positional relationship with the other object, and it is thus possible to suppress a feeling of strangeness felt by the user. More specifically, in the example illustrated in FIG. 6, when the object including an avatar SB0 is displayed at a position A_{MA} of the original object MA (chair) in a superimposed manner, the avatar SB0 and the object MB (desk) greatly overlap each other, and, this may be a case with an image that may give a feeling of strangeness, such as a case in which the avatar caves in the desk. In contrast, in the example illustrated in FIG. 6, the display object S (the first object SA and the second object SB) is displayed at the superimposed position (a position A_{SA}) such that an area in which the first object SA (chair) and the second object SB (avatar) are superimposed onto the area of the object MB (desk) is reduced. As a result of this, it is possible to reduce a feeling of strangeness about an appearance. In addition, in a case in which the object MB overlaps the display object S, it is also possible to reduce a feeling of strangeness about an appearance by generating a missing part in which the display object S overlaps the display object S.

### Second Embodiment

In the following, a second embodiment will be described. In the second embodiment, a method of setting the superimposed position is different from that described above in the first embodiment. In the second embodiment, a description of the configuration that is the same as that described in the first embodiment will be omitted.

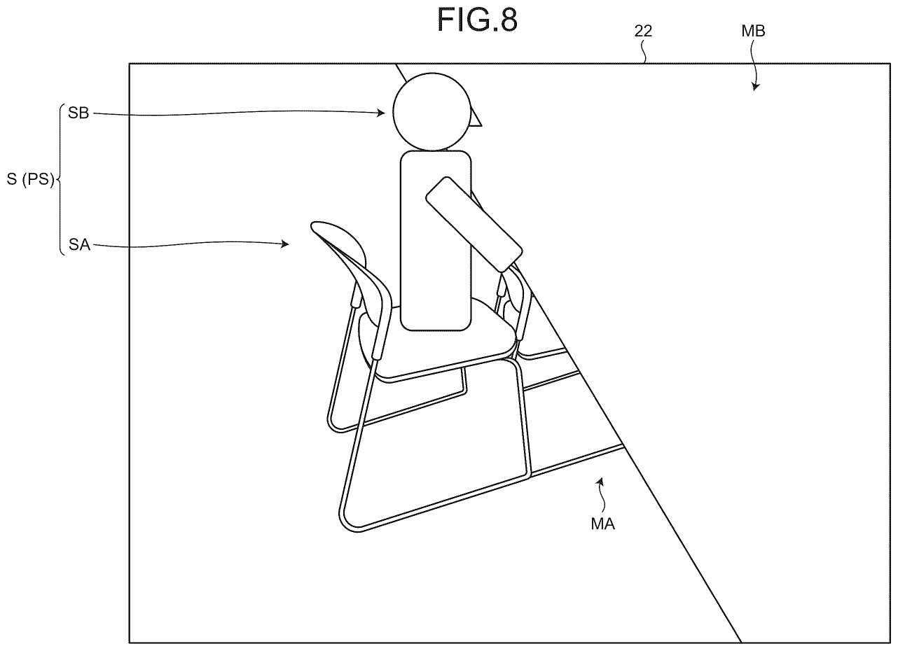

FIG. 8 is a schematic diagram illustrating one example of an image displayed by the display according to the second embodiment. In the second embodiment, the superimposed position setting unit 48 calculates a first superimposed area and a second superimposed area, and sets a superimposed position based on the first superimposed area and the second superimposed area. The first superimposed area mentioned here indicates an area in which the display object S (the first object SA and the second object SB) and the target object MA are superimposed each other when it is assumed that the display object S (the first object SA and the second object SB) is displayed at the superimposed position. Furthermore, the second superimposed area mentioned here indicates an area in which the display object S (the first object SA and the second object SB) and the other object MB (an object other than the target object MA) are superimposed each other when it is assumed that the display object S (the first object SA and the second object SB) is displayed at the superimposed position. Furthermore, the first superimposed area is able to be calculated based on the size of the display object S (the first object SA and the second object SB) and the size of the target object MA, the superimposed position, and the position of the target object MA. Similarly, the second superimposed area is able to be calculated based on the display object S (the first object SA and the second object SB), the size of the other object MB, and the superimposed position and the position of the other object MB.

More specifically, it is preferable that the superimposed position setting unit 48 sets the superimposed position such that the first superimposed area is equal to or greater than a first predetermined area, and, also, the second superimposed area is equal to or less than a second predetermined area. The first predetermined area and the second predetermined area may be arbitrarily set. More specifically, the superimposed position setting unit 48 sets, as a superimposed position, a position optimized by optimization calculation such that the first superimposed area becomes large as much as possible and the second superimposed area becomes small as much as possible.

In this way, in the second embodiment, the superimposed position is set based on the first superimposed area and the second superimposed area. As a result of this, it is possible to determine the superimposed position in accordance with the degree of superimposition of the display object S with respect to the target object MA and the other object MB, so that it is possible to further suitably suppress a feeling of strangeness about an appearance. In addition, in the second embodiment, the superimposed position is determined such that the size of the first superimposed area between the display object S and the target object MA is increased, and, also, the size of the second superimposed area between the display object S and the other object MB is decreased. As a result of this, it is possible to hide the target object MA by the display object S as much as possible while suppressing a feeling of strangeness caused by the positional relationship between the display object S and the other object MB, and it is thus possible to further suitably suppress a feeling of strangeness about an appearance. In other words, for example, as illustrated in FIG. 6, in a case in which the first superimposed area between the display object S and the target object MA is relatively small, the display object S and the target object MA, each of which indicates the same chair, are displayed side by side, so that it may possibly cause the user U to have a feeling of strangeness. In contrast, as illustrated in FIG. 8, it is possible to suppress a feeling of strangeness felt by the user U by increasing the first superimposed area between the display object S and the target object MA as much as possible.

### Effects

As described above, the display device 10 according to the present application includes the target object extraction unit 42, the first object generation unit 44, the superimposed position setting unit 48, the display object generation unit 50, and the display controller 52. The target object extraction unit 42 extracts the target object that is included in the main image PM captured by the image capturing unit 28. The first object generation unit 44 generates the first object SA that is the image obtained by compensating for the target object MA based on the target object MA. The superimposed position setting unit 48 sets the superimposed position that is the position at which the first object SA is displayed in the main image PM. The display object generation unit 50 sets the display mode of the first object SA based on the position of the other object MB other than the target object MA included in the main image PM and based on the superimposed position, and generates the display object S. The display controller 52 causes the display object S to be displayed at the superimposed position. According to the present application, it is possible to display the target object MA as the display object S by adjusting the display mode in accordance with the positional relationship with the other object MB. As a result of this, it is possible to reduce a feeling of strangeness about an appearance caused by the positional relationship with the other object MB, and it is thus possible to suppress a feeling of strangeness felt by the user.

The superimposed position setting unit 48 sets the position that is different from the position of the target object MA as the superimposed position. According to the present application, it is possible to further suitably suppress a feeling of strangeness about an appearance.

The display device 10 according to the present application further includes the second object generation unit 46 that generates the second object SB. The display object generation unit 50 generates an image that includes the first object SA and the second object SB as the display object S. The superimposed position setting unit 48 sets, as the superimposed position, a position at which an area in which the second object SB and the other object MB are superimposed indicates a value equal to or less than the predetermined value when the display object S is displayed at the superimposed position. According to the present application, it is possible to further suitably suppress a feeling of strangeness about an appearance.

The superimposed position setting unit 48 sets the superimposed position based on the area (the first superimposed area) in which the display object S displayed at the superimposed position and the target object MA are superimposed each other, and the area (the second superimposed area) in which the display object S displayed at the superimposed position and the other object MB are superimposed each other. As a result of this, it is possible to determine the superimposed position in accordance with the degree of superimposition of the display object S with respect to both of the target object MA and the other object MB, so that it is possible to further suitably suppress a feeling of strangeness about an appearance.

The display object generation unit 50 generates the shadow image SC corresponding to the shadow of the display object S, and the display controller 52 causes the display object S and the shadow image SC to be displayed. By displaying the shadow image SC, it is possible to add the shadow same as that of a real object to the display object S, and it is thus possible to further suitably suppress a feeling of strangeness about an appearance.

Although the application has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The display apparatus and the display method according to the present application can be used for displaying images.

According to the present embodiment, it is possible to suppress a feeling of strangeness felt by a user.

What is claimed is:

1. A display device comprising:
a target object extraction unit configured to extract a target object that is included in a main image captured by an image capturing unit;
a first object generation unit configured to generate a first object that is an image obtained by compensating for the target object based on the target object;
a superimposed position setting unit configured to set a superimposed position that is a position at which the first object is displayed in the main image;
a display object generation unit configured to set a display mode of the first object based on a position of another object that is superimposed onto the target object included in the main image and based on the superimposed position, and to generate a display object; and
a display controller configured to cause the display object to be displayed at the superimposed position.

2. The display device according to claim 1, wherein the superimposed position setting unit is further configured to set a position that is different from the position of the target object as the superimposed position.

3. The display device according to claim 1, further comprising a second object generation unit configured to generate a second object, wherein
the display object generation unit is further configured to generate an image that includes the first object and the second object as the display object, and
the superimposed position setting unit is further configured to set, as the superimposed position, a position at which an area in which the second object and the another object are superimposed indicates a value equal to or less than a predetermined value when the display object is displayed at the superimposed position.

4. The display device according to claim 1, wherein the superimposed position setting unit is further configured to set the superimposed position based on an area in which the display object displayed at the superimposed position and the target object are superimposed and based on an area in which the display object displayed at the superimposed position and the another object are superimposed.

5. The display device according to claim 1, wherein
the display object generation unit is further configured to generate a shadow image corresponding to a shadow of the display object, and
the display controller is further configured to cause the display object and the shadow image to be displayed.

6. A display method comprising:
extracting a target object that is included in a main image captured by an image capturing unit;
generating a first object that is an image obtained by compensating for the target object based on the target object;
setting a superimposed position that is a position at which the first object is displayed in the main image;
setting a display mode of the first object based on a position of another object that is superimposed onto the target object included in the main image and based on the superimposed position, and generating a display object; and
displaying the display object at the superimposed position.

7. A non-transitory storage medium that stores a program that causes a computer to execute a process comprising:
a step of extracting a target object that is included in a main image captured by an image capturing unit;
a step of generating a first object that is an image obtained by compensating for the target object based on the target object;
a step of setting a superimposed position that is a position at which the first object is displayed in the main image;
a step of setting a display mode of the first object based on a position of another object that is superimposed onto the target object included in the main image and based on the superimposed position, and generating a display object; and
a step of displaying the display object at the superimposed position.
